(19) United States
(12) Patent Application Publication
(10) Pub. No.: US 2012/0191610 A1
(43) Pub. Date: Jul. 26, 2012

(54) ONLINE PAYMENT FOR OFFLINE PURCHASE

(76) Inventor: Satya Parakash Prasad, Chennai (IN)

(21) Appl. No.: 13/436,619

(22) Filed: Mar. 30, 2012

Related U.S. Application Data
(63) Continuation of application No. 13/077,489, filed on Mar. 31, 2011.

(51) Int. Cl. G06Q 20/14; G06Q 20/40

(52) U.S. Cl. 705/44; 705/40

(57) ABSTRACT

A user receives a unique purchase identifier from a merchant during an offline purchase transaction. The merchant holds the purchase. The user makes an online payment at a later time by entering the purchase identifier through a payment provider, who retrieves details of the purchase and processes the payment if the user approves of the payment. The merchant is notified and releases or ships the purchase to the user.

### CROSS REFERENCE TO RELATED APPLICATION

The present application is a continuation of U.S. patent application Ser. No. 13/077,489, filed Mar. 31, 2011, which is incorporated by reference in its entirety.

### BACKGROUND

1. Field of the Invention

The present invention generally relates to financial transactions, and in particular, to making an online payment for an offline purchase.

2. Related Art

Purchases and payments are typically made between merchants and consumers in a variety of ways. The traditional way is offline purchase and offline payment. For example, a consumer picks up groceries at a market (offline purchase) and pays for the groceries at the market (offline payment), such as with cash or a check. Another type of transaction is an online purchase and an offline payment. In this situation, the consumer makes a purchase through a website by selecting one or more items and makes the payment when the consumer picks up the purchase. An example is a consumer ordering pizza through an online site and then paying for the pizza at the pizza restaurant when the consumer picks up the pizza.

A third type of transaction, which is becoming more and more popular, is an online purchase and an online payment. Here, the consumer accesses an online shopping site, selects desired items or services, and makes the payment while still online. Online payments can be made through a payment provider, such as PayPal, Inc. of San Jose, Calif. Online payments are attractive to consumers due in part to convenience, security, and consumer protection. Thus, consumers may desire to make an online payment if possible, as opposed to an offline payment.

However, with an offline purchase, the merchant typically requires payment to be made offline as well, i.e., at the point of sale. If the consumer does not or cannot make the offline payment with the offline purchase, such as not having the cash, the consumer may miss out on a desired item and the merchant may lose a sale. Furthermore, merchants who do not have online shopping sites may miss out on a segment of the market that only wants to make online payments.

Therefore, a need exists for the ability to make an online payment for an offline purchase.

### SUMMARY

In one embodiment of the present invention, a consumer selects one or more items for purchase at a physical merchant location. The merchant “holds” the purchase for the consumer, giving the consumer a unique identifier, such as a barcode or a number, to identify the purchase. The consumer then goes online, such as through a computing device, to access a payment provider service site. The consumer enters the identifier through the site so that the site can retrieve the purchase information. The consumer can then make an online payment through the site using the consumer's account with the payment provider. The payment provider processes the payment, such as by debiting the consumer account and crediting the merchant account. The payment provider may then notify the merchant of a payment confirmation associated with the specific purchase. Once received, the merchant releases the item, such as shipping it to the consumer. As a result, the consumer is able to make an online payment of an offline purchase.

In one embodiment, the merchant holds the items (or purchase) for a specific period of time. If payment is not made within the time period, the merchant makes the items available to others. This provides some security to the consumer that the items will be held. However, the merchant may lose a sale if another consumer wanted to purchase the items during this hold period. The disadvantage to the merchant can be minimized by reducing the hold time.

In another embodiment, the merchant is free to sell the purchase at any time until the consumer makes the payment. This benefits the merchant, but gives no assurance to the consumer. The merchant may give the consumer notice if another consumer is interested in the item, such that the consumer must pay immediately or within a shortened time period.

These and other features and advantages of the present invention will be more readily apparent from the detailed description of the embodiments set forth below taken in conjunction with the accompanying drawings.

### BRIEF DESCRIPTION OF THE FIGURES

FIG. 1 shows a process for a user to set up a “quick-order” option using a word or phrase according to one embodiment;

FIG. 2 shows a process for conducting an order using the “quick-order” option according to one embodiment;

FIG. 3 is block diagram of a networked system suitable for implementing the process of FIGS. 1 and 2 according to an embodiment; and

FIG. 4 is a block diagram of a computer system suitable for implementing one or more components in FIG. 3 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

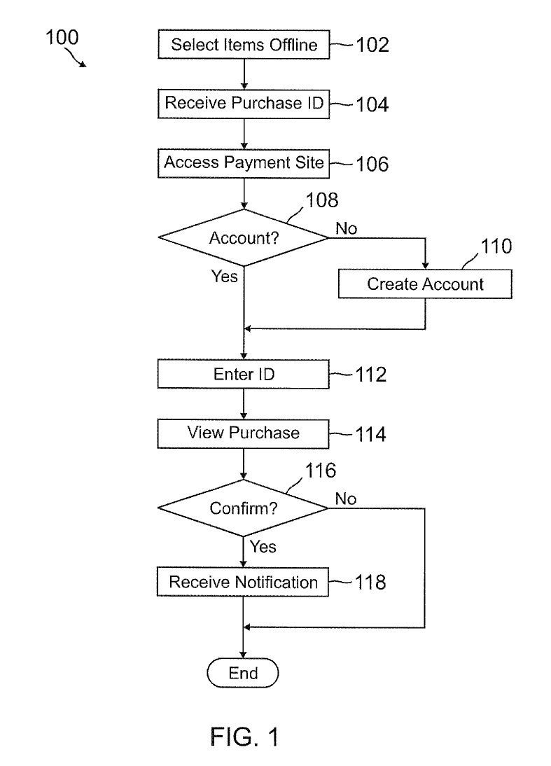

FIG. 1 is a flowchart 100 showing a process for a user to make an online payment for an offline purchase according to one embodiment. At step 102, the user selects items offline, such as at a store, market, office, swap meet, or any physical location where the user can pick an item or service. For example, a user may be traveling and locates an item at a store outside the United States. The user may want to make the purchase, but does not want to make the payment at that time, e.g., either not having the funds or funding instrument available or unwilling to make a payment (e.g., for fear of exposing sensitive information).

After item selection, the user takes the items to the merchant, such as at a counter, cash register, etc. The user does not need to physically select desired items, but may instead select items through a catalog, terminal, computing device, menu, verbally to the merchant, or writing down a description of the item. The user then informs the merchant that the user wishes the merchant to hold the selected items and that the user will make the payment at a later time. This can be a service already offered by the merchant through a payment provider, such as PayPal, Inc. of San Jose, Calif. There may be specific terms of using this option, such as when the user would need to make the payment, how long the merchant will hold the items, etc.

The merchant then creates an invoice with a total for the purchase, which may include shipping costs and any other fees, such as a service fee, and generates a purchase identifier for the transaction. In one embodiment, the purchase identifier is unique for the merchant, i.e., there is no other transaction with the merchant associated with the particular identifier. The purchase identifier, along with details of the purchase, are communicated to the payment provider for storage. Information communicated may include a description of the items purchased, individual and total price, any additional charges, such as shipping, tax, and service fees, merchant information, such as a merchant ID, merchant name, merchant address, merchant account number, etc., terms of the purchase, such as when the user is required to make payment, and/or user information, such as a user identifier. The user then receives this purchase identifier from the merchant at step 104. The purchase identifier, which is associated with the purchase, allows details of the purchase to be viewed/accessed through the identifier. The identifier may take any number of suitable forms. Examples include a sequence of numbers, letters, symbols, and/or characters in any combination, a visual code, such as a bar code or QR code, an image, a sound, a video, etc. However, the payment provider can also provide merchants with a form having placeholders to document transaction details each embedded with a unique barcode number. The content would be in languages as requested by merchants. The form can have date of expected payment, ship to address and expected shipping date. Details or the form can be communicated to the user.

After receiving the purchase identifier, the merchant retains the items, and the user leaves with the purchase identifier. When the user wishes to make the payment, such as when the user returns from his travels or when the user is able to access a trusted computing device, the user access the payment site, at step 106, such as through the computing device. The computing device may be a PC, laptop, tablet, smart phone, or any device that allows online access to the payment site. Accessing may include entering in a URL address for the site, selecting a link, or any other suitable means. In one embodiment, the user may be sent one or more reminders to make the payment when the payment due date is coming up.

Once the user is on the payment provider site, the user creates an account at step 110 if the user does not have an account with the payment provider, as determined at step 108. A user account may be required for the user to make the payment. Creating an account may involve the user providing certain requested information, such as a username, a password/PIN, an email address, a shipping/billing address, a funding source, or any other such information.

After the account is created or accessed, such as by entering in a user name and password/PIN, the user enters, at step 112, the purchase identifier received at step 104. The user may first need to access the correct page, such as through a tab or link. Depending on the form of the purchase identifier, the user may enter the identifier in any suitable way. If the identifier is a sequence of numbers, characters, letters, and/or symbols, the user may manually enter the sequence through a keypad or keyboard. If the identifier is a bar code or QR code, the user may scan the code using the user device. If the identifier is an image, sound, or video, the user may select the image, sound, or video from a group of other images, sounds, or videos. The user may also speak the identifier, such as through a microphone on the user device.

Once the identifier is entered, the payment provider retrieves the purchase details associated with the entered purchase identifier. The user is then presented with all or some of the purchase details, at step 114, for viewing, such as on the user's device.

If the purchase details are correct and the user still wants to continue with the payment, as determined at step 116, the user may proceed with payment. This may be simply selecting a link or button to confirm or pay. The payment provider then processes the payment, such as debiting the user's account and crediting a merchant account. If the process is successful, the user receives a notification, at step 118, that the payment was completed. A similar notification can also be sent to the merchant, so that the merchant can proceed with releasing or shipping the purchased items. Notification can be my email, text, voice, or any other suitable means.

If the user does not confirm the payment at step 116, such as if the purchase details are incorrect (the user may have entered the wrong identifier) or the user changed his/her mind, the process can end without any payment made. The user may also be given the option of entering the purchase identifier again, such as when the user entered a wrong identifier initially.

Thus, using the above method, a user can make a purchase offline and then make the payment online to receive the purchased items.

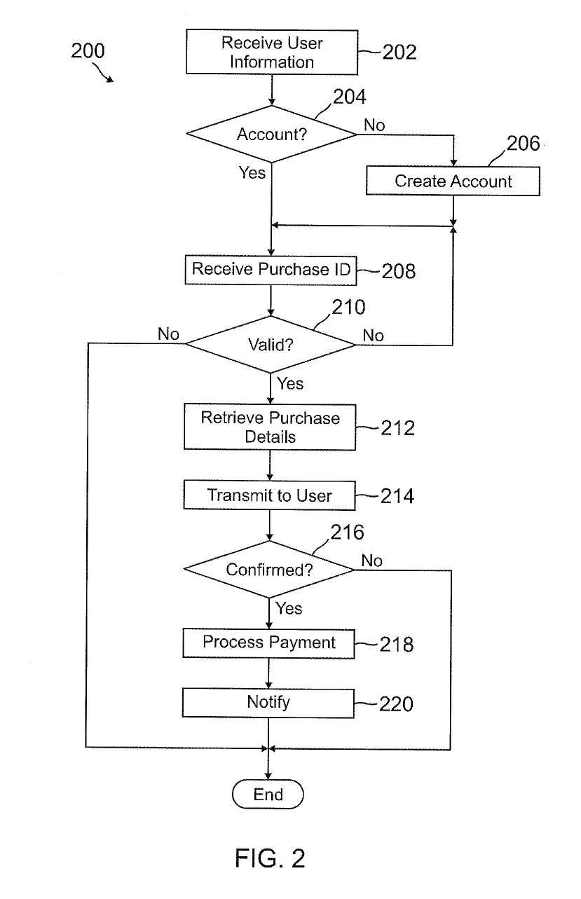

FIG. 2 is a flowchart 200 showing a process for a payment provider to process an online payment for an offline purchase according to one embodiment. Initially, the payment provider receives a purchase identifier and purchase details from a merchant of a “purchase” made by the user offline. The payment provider can receive this electronically through a merchant computing device or other means. For example, the merchant may fax or mail the information. The payment provider then stores this information. If a user identifier is included, the payment provider associates the information with a specific user.

When the user wishes to make a payment online for the offline purchase, the process starts at step 202, where the payment provider receives user information. User information may include a user name, email, or other identifier, along with a password or PIN. The information may be received electronically through a PC, laptop, tablet, smart phone, or any suitable computing device.

The payment provider then determines, at step 204, whether the user has an account with the payment provider. This may include determining whether the user-entered information corresponds to a proper account. If no valid account exists, the payment provider may create an account for the user at step 206. The payment provider may notify the user that to make a payment through the payment provider, the user must create an account. The payment provider may request certain information from the user to create the account. Such information is conventionally known.

Once a valid user account is created or accessed, the payment provider receives, at step 208, the purchase identifier from the user. The identifier may be received electronically or other means and may be through user entry of data or user selection from a group of options.

A determination is then made, at step 210, whether the received purchase identifier is valid. An invalid purchase identifier may result from the user entering or selecting an identifier not associated with the user, not associated with any purchase stored with the payment provider, or an expired or used identifier. If the payment provider determines that the purchase identifier is invalid, the process may end or the payment provider may allow the user to re-enter the purchase identifier at step 208.

When a valid identifier is received, the payment provider retrieves details of the purchase associated with the purchase identifier at step 212. Once the details are obtained, the payment provider transmits or presents some or all of the details to the user at step 214. In one embodiment, the complete invoice is shown, with detailed itemized purchases, shipping information, totals, merchant name, date of purchase, etc. In another embodiment, only a portion of the details may be shown, such as the merchant name, a list of items, the total dollar amount, and the shipping address.

The payment provider then waits for the user to confirm or cancel the process. If the user wishes to cancel, the user may select a “Cancel” or similar link/button, end the session, or other means. If the payment provider receives an affirmative indication that the user wishes to cancel or the session times or is otherwise terminated, the payment provider ends the process.

However, if the user wishes to confirm the payment, the payment provider proceeds to process the payment at step 218. A confirmation may be received by the user selecting an appropriate link or button, such as “Pay Now.” Payment processing may include determining whether the payment request can be completed. Reasons the payment may not be made may include the user having insufficient funds in the account, conditions not met for making the payment, such as time expired, the merchant or type of goods not allowed for purchase from the user's account, the merchant not having a valid account, and/or any issues with fraud/risk. If the payment cannot be completed, the payment provider may notify the user and/or the merchant at step 220. Notification can be through any suitable means, including text, email, or voice.

If the payment provider determines the payment can be made, funds may be debited from the user's account and funds may be credited to a merchant account. Once the payment is made, the payment provider may notify the user and/or the merchant at step 220 accordingly. When the merchant receives the confirmation, the merchant may release or ship the purchased items. If the user wishes to pick up the items, the user may go to a physical merchant location and present some indication of payment, such as an identification that the merchant can match to a confirmed payment or a confirmation or receipt from the payment provider.

In some embodiments, the payment provider may send one or more reminders to the user to make a payment for an earlier offline purchase. For example, if the time for payment is about to expire (e.g., in a day or two), the user may be reminded to make the payment or lose the purchase. The user may also be sent reminders or notifications for various reasons. For example, if the merchant is about to re-sell or release one or more purchased items, the merchant may notify the user that a payment must be made within a certain time.

In other embodiments, the merchant may notify the payment provider and/or the user if one or more of the purchased items are no longer available. For example, the merchant may have decided to sell or put back one or more of the items (preferably the user would have known that the merchant hold was “at-will”). Upon notification, the payment provider removes the details and/or purchase identifier or otherwise processes the information so that the user cannot inadvertently make a payment for undeliverable goods.

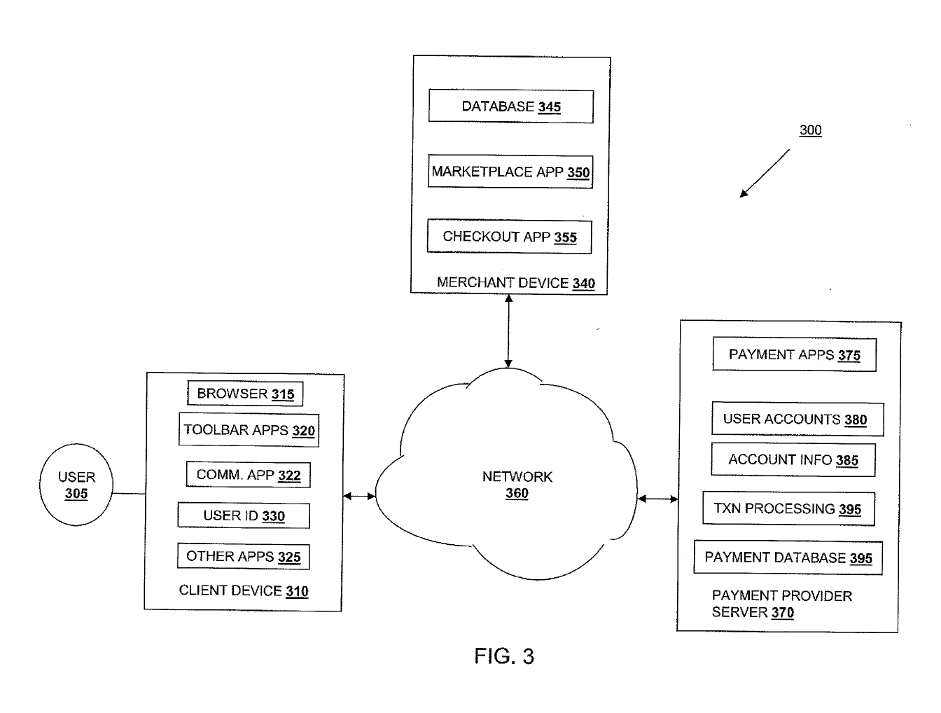

FIG. 3 is a block diagram of a networked system 300 configured to handle a financial transaction between a payment recipient (e.g., merchant) and a payment sender (e.g., user or consumer), such as described above, in accordance with an embodiment of the invention. System 300 includes a user device 310, a merchant server 340, and a payment provider server 370 in communication over a network 360. Payment provider server 370 may be maintained by a payment provider, such as PayPal, Inc. of San Jose, Calif. A user 305, such as the sender or consumer, utilizes user device 310 to perform a payment transaction with merchant server 340 using payment provider server 370.

User device 310, merchant server 340, and payment provider server 370 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

Network 360 may be implemented as a single network or a combination of multiple networks. For example, in various embodiments, network 360 may include the Internet or one or more intranets, landline networks, wireless networks, and/or other appropriate types of networks.

User device 310 may be implemented using any appropriate hardware and software configured for wired and/or wireless communication over network 360. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 310 may include one or more browser applications 315 which may be used, for example, to provide a convenient interface to permit user 305 to browse information available over network 360. For example, in one embodiment, browser application 315 may be implemented as a web browser configured to view information available over the Internet or access a website of the payment provider. User device 310 may also include one or more toolbar applications 320 which may be used, for example, to provide client-side processing for performing desired tasks in response to operations selected by user 305. In one embodiment, toolbar application 320 may display a user interface in connection with browser application 315 as further described herein.

User device 310 may further include other applications 325 as may be desired in particular embodiments to provide desired features to user device 310. For example, other applications 325 may include security applications for implementing client-side security features, programmatic client applications for interfacing with appropriate application programming interfaces (APIs) over network 360, or other types of applications. Applications 325 may also include email, texting, voice and IM applications that allow user 305 to send and receive emails, calls, and texts through network 360, as well as applications that enable the user to communicate, place orders, and make payments through the payment provider as discussed above. User device 310 includes one or more user identifiers 330 which may be implemented, for example, as operating system registry entries, cookies associated with browser application 315, identifiers associated with hardware of user device 310, or other appropriate identifiers, such as used for payment/user/device authentication. In one embodiment, user identifier 330 may be used by a payment service provider to associate user 305 with a particular account maintained by the payment provider as further described herein. A communications application 322, with associated interfaces, enables user device 310 to communicate within system 300.

Merchant server 340 may be maintained, for example, by a merchant or seller offering various products and/or services in exchange for payment to be received over network 360. Generally, merchant server 340 may be maintained by anyone or any entity that receives money, which includes charities as well as retailers and restaurants. Merchant server 340 includes a database 345 identifying available products and/or services (e.g., collectively referred to as items) which may be made available for viewing and purchase by user 305. Accordingly, merchant server 340 also includes a marketplace application 350 which may be configured to serve information over network 360 to browser 315 of user device 310. In one embodiment, user 305 may interact with marketplace application 350 through browser applications over network 360 in order to view various products, food items, or services identified in database 345.

Merchant server 340 also includes a checkout application 355 which may be configured to facilitate the purchase by user 305 of goods or services identified by marketplace application 350. Checkout application 355 may be configured to accept payment information from or on behalf of user 305 through payment service provider server 370 over network 360. For example, checkout application 355 may receive and process a payment confirmation from payment service provider server 370, as well as transmit transaction information to the payment provider and receive information from the payment provider (e.g., a transaction ID). Checkout application 355 may also be configured to accept one or more different funding sources for payment. Furthermore, checkout application 355 may be used to generate a purchase identifier associated with details of a user purchase, where the user then uses the identifier to pay online for the purchase at a later time.

Payment provider server 370 may be maintained, for example, by an online payment service provider which may provide payment between user 305 and the operator of merchant server 340. In this regard, payment provider server 370 includes one or more payment applications 375 which may be configured to interact with user device 310 and/or merchant server 340 over network 360 to facilitate the purchase of goods or services by user 305 of first user device 310 using a purchase identifier obtained from an offline purchase as discussed above.

Payment provider server 370 also maintains a plurality of user accounts 380, each of which may include account information 385 associated with individual users. For example, account information 385 may include private financial information of users of devices such as account numbers, passwords, device identifiers, user names, phone numbers, credit card information, bank information, or other financial information which may be used to facilitate online transactions by user 305. Advantageously, payment application 375 may be configured to interact with merchant server 340 on behalf of user 305 during a transaction with checkout application 355 to track and manage purchases made by users and which funding sources are used.

A transaction processing application 390, which may be part of payment application 375 or separate, may be configured to receive information from a user device and/or merchant server 340 for processing and storage in a payment database 395. Transaction processing application 390 may include one or more applications to process information from user 305 and/or the merchant for processing an online payment from an offline purchase using a purchase identifier as described herein. As such, transaction processing application 390 may store details of an order and associate the details with a purchase identifier for individual users. Payment application 375 may be further configured to determine the existence of and to manage accounts for user 305, as well as create new accounts if necessary, such as the set up, management, and use of purchase identifiers.

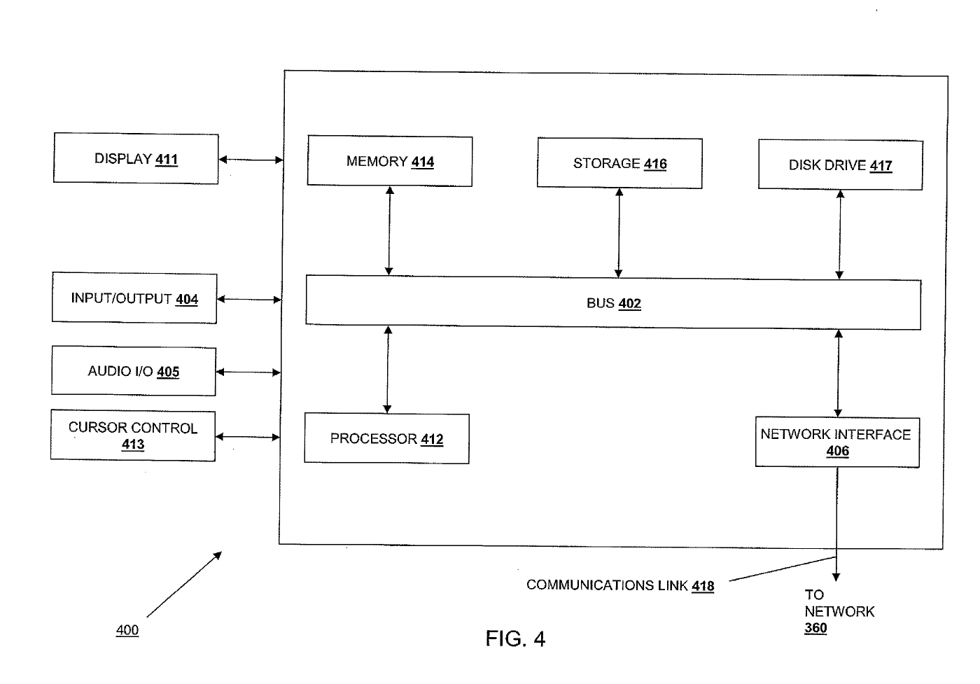

FIG. 4 is a block diagram of a computer system 400 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. For example, the description has focused on an offline purchase. However, it may be suitable to use the purchase identifier to pay for an online purchase at a later time. Thus, the present disclosure is limited only by the claims.

What is claimed is:

1. A system for processing a payment request, comprising:
a memory storing user account information, wherein the information comprises a purchase identifier for a transaction associated with a user; and
a processor coupled to the memory and operable to:
receive a purchase identifier associated with a purchase made a user at an earlier time;
determine details of the purchase from the purchase identifier; and
process the payment request.

2. The system of claim 1, wherein the processor is further operable to receive user information.

3. The system of claim 1, wherein the processor is further operable to communicate at least some of the details to the user prior to the processing.

4. The system of claim 1, wherein the processor is further operable to receive a confirmation from the user prior to the processing.

5. The system of claim 1, wherein the processing comprises determining whether conditions of the purchase are met.

6. The system of claim 5, wherein the conditions comprise a time to pay.

7. The system of claim 1, wherein the processor is further operable to receive a notification from a seller that one or more items from the purchase are no longer available.

8. The system of claim 1, wherein the purchase was made offline.

9. The system of claim 8, wherein the purchase identifier is given to the user at the time of the purchase.

10. The system of claim 1, wherein the purchase is released when the payment request is processed and notification sent to the seller.

11. The system of claim 1, wherein the purchase identifier comprises a sequence of letters, characters, symbols, and/or numbers, an image, a video, or a sound.

12. The system of claim 1, wherein the purchase identifier is unique to the merchant.

13. A method of processing a payment request, comprising:
receiving, by a processor of a service provider, a purchase identifier associated with a purchase made a user at an earlier time;
determining details of the purchase from the purchase identifier; and
processing the payment request.

14. The method of claim 13, wherein the processing comprises determining whether conditions of the purchase are met.

15. The method of claim 14, wherein the conditions comprise a time to pay.

16. The method of claim 13, wherein the purchase was made offline.

17. The method of claim 16, wherein the purchase identifier is given to the user at the time of the purchase.

18. The method of claim 13, wherein the purchase identifier is unique to the merchant.

19. A non-transitory machine-readable medium comprising a plurality of machine-readable instructions which when executed by one or more processors of a server are adapted to cause the server to perform a method comprising:
receiving, by a service provider, a purchase identifier associated with a purchase made a user at an earlier time;
determining details of the purchase from the purchase identifier; and
processing the payment request.

20. non-transitory machine-readable medium of claim 19, wherein the processing comprises determining whether conditions of the purchase are met.

21. The non-transitory machine-readable medium of claim 20, wherein the conditions comprise a time to pay.

22. The non-transitory machine-readable medium of claim 19, wherein the purchase was made offline.

23. The non-transitory machine-readable medium of claim 22, wherein the purchase identifier is given to the user at the time of the purchase.

24. The non-transitory machine-readable medium of claim 19, wherein the purchase identifier is unique to the merchant.
